(19) United States
(12) Patent Application Publication
(10) Pub. No.: US 2021/0253239 A1
(43) Pub. Date: Aug. 19, 2021

(54) TAIL SITTER STOP-FOLD AIRCRAFT

(71) Applicant: Bell Textron Inc., Fort Worth, TX (US)

(72) Inventors: Steven Ray Ivans, Ponder, TX (US); Brent Chadwick Ross, Flower Mound, TX (US); Danielle Lynn Moore, Arlington, TX (US); Berlin Bernard Benfield, Grapevine, TX (US); Jason Paul Hurst, Fort Worth, TX (US)

(73) Assignee: Bell Textron Inc., Fort Worth, TX (US)

(21) Appl. No.: 16/795,426

(22) Filed: Feb. 19, 2020

(51) Int. Cl. B64C 29/04; B64C 27/50; B64D 27/10; B64D 35/04; B64C 25/32; B64C 5/06; B64C 5/08; B64C 5/04; B64C 7/00

(52) U.S. Cl. CPC B64C 29/04; B64C 27/50; B64D 27/10; B64D 35/04; B64C 7/00; B64C 5/06; B64C 5/08; B64C 5/04; B64C 25/32

(57) ABSTRACT

Embodiments are directed to a high speed, vertical lift aircraft that has vertical take-off and landing (VTOL) capability and is capable of converting to a forward-flight mode (e.g., prop-mode). The rotors blades can be folded for high speed forward flight propelled by a turbine engine (e.g., jet-mode). The rotor blades on the tail sitter aircraft have a “stop-fold” capability, which means that the rotor blades are stopped in flight and folded back to reduce drag. This allows the tail sitter aircraft to achieve a higher speed than a tilt-rotor aircraft. In some embodiments, the tail sitter aircraft achieves both rotor-borne flight and jet-borne flight by having two separate engines. An additional advantage of the tail-sitter aircraft versus a horizontally oriented fixed engine aircraft is that supplemental jet thrust can be used for take-off if desired.

### BACKGROUND

Fixed-wing aircraft, such as airplanes, are capable of flight using wings that generate lift in response to the forward airspeed of the aircraft. The forward airspeed is generated by thrust from one or more jet engines or propellers. The wings generally have an airfoil cross section that deflects air downward as the aircraft moves forward, generating the lift force to support the aircraft in flight. Fixed-wing aircraft, however, typically require a runway that is hundreds or thousands of feet long for takeoff and landing.

Unlike fixed-wing aircraft, vertical takeoff and landing (VTOL) aircraft do not require runways. Instead, VTOL aircraft are capable of taking off, hovering and landing vertically. One example of a VTOL aircraft is a helicopter, which is a rotorcraft having one or more rotors that provide lift and thrust to the aircraft. The rotors not only enable hovering and vertical takeoff and landing, but also enable forward, backward and lateral flight. These attributes make helicopters highly versatile for use in congested, isolated or remote areas. Helicopters, however, typically lack the forward airspeed of fixed-wing aircraft due to the phenomena of retreating blade stall and advancing blade compression.

Tiltrotor aircraft attempt to overcome this drawback by including a set of proprotors that can change their plane of rotation based on the operation being performed. Tiltrotor aircraft generate lift and propulsion using proprotors that are typically coupled to nacelles mounted near the ends of a fixed wing. The nacelles rotate relative to the fixed wing such that the proprotors have a generally horizontal plane of rotation for vertical takeoff, hovering and landing and a generally vertical plane of rotation while cruising in forward flight, wherein the fixed wing provides lift and the proprotors provide forward thrust. In this manner, tiltrotor aircraft combine the vertical lift capability of a helicopter with the speed and range of fixed-wing aircraft.

Tail sitter aircraft are configured to land and take off vertically from their tail section. Unlike a tiltrotor, tail-sitter aircraft convert to forward flight by the entire aircraft tilting from vertical to horizontal. This saves the weight and complication of tilting rotors. The longitudinal fuselage axis of a tail sitter aircraft is oriented generally vertical for hover, takeoff, and landing and is oriented generally horizontal during forward flight. Rotor blades driven by a rotary propulsion system are used to generate vertical thrust during takeoff, hover, and landing. Horizontal thrust has traditionally been generated by the rotary propulsion system in combination with lift generated by one or more fixed wings that enable forward flight.

### SUMMARY

Embodiments are directed to a high speed, vertical lift aircraft that has vertical take-off and landing (VTOL) capability and is capable of converting to a forward-flight mode (e.g., prop-mode). The rotors blades can be folded for high speed forward flight propelled by a turbine engine (e.g., jet-mode). The rotor blades on the tail sitter aircraft have a “stop-fold” capability, which means that the rotor blades are stopped in flight and folded back to reduce drag. This allows the tail sitter aircraft to achieve a higher speed than a tilt-rotor aircraft. In some embodiments, the tail sitter aircraft achieves both rotor-borne flight and jet-borne flight by having two separate engines. An additional advantage of the tail-sitter aircraft versus a horizontally oriented fixed engine aircraft is that supplemental jet thrust can be used for take-off if desired.

In one embodiment, a tail sitter aircraft comprises a fuselage having a longitudinal axis, a wing attached to the fuselage at a first end of the wing, a proprotor assembly having a plurality of rotor blades, the proprotor assembly mounted at a second end of the wing so that an axis of the proprotor assembly maintains an alignment that is generally parallel to the fuselage longitudinal axis, wherein the plurality of rotor blades are configured to move between an extend position and a folded position, a first engine configured to generate torque, wherein the proprotor assembly is configured to rotate the rotor blades using torque generated by the first engine, and a second engine configured to generate a thrust force that is adapted to drive the tail sitter aircraft in a forward direction.

The tail sitter aircraft may further comprise a rotor drive system that is configured to distribute the torque from the first engine to the proprotor assembly. The first engine may be a turboshaft engine, and the second engine may be a gas turbine engine. The thrust force generated by the second engine may be exhaust airflow from the gas turbine engine. Alternatively, the first engine and the second engine may be a single gas turbine engine that is coupled to a power shaft to provide torque and a fan section to provide thrust.

The tail sitter aircraft may further comprise landing members that are positioned to allow the tail sitter aircraft to land and takeoff from a configuration wherein the fuselage longitudinal axis is generally perpendicular to the ground. The landing members may be skid members, shock-absorbing members, pneumatic shock struts, mechanical spring assemblies, or wheels, for example.

The tail sitter aircraft may further comprise a vertical stabilizer. The vertical stabilizer may be mounted on the wing and co-located with the proprotor assembly. Alternatively, the vertical stabilizer may be mounted on the wing at a position inboard or outboard of the proprotor assembly. The tail sitter aircraft may further comprise canards mounted on the fuselage.

The tail sitter aircraft may further comprise a pylon for mounting the proprotor assembly at an end of the wing. A wing extension may be attached to the pylon at a position outboard of the wing. The first engine may be mounted within the pylon.

In another embodiment, a tail sitter aircraft comprises a fuselage having a longitudinal axis, two wings attached to the fuselage and extending outward from the fuselage on opposite sides of the tail sitter aircraft, a pylon mounted on each wing, the pylon configured to hold a proprotor assembly having a plurality of rotor blades, an axis of rotation for the rotor blades having an alignment that is generally parallel to the fuselage longitudinal axis, wherein the plurality of rotor blades are configured to move between an extend position and a folded position, a first engine configured to provide torque to at least one proprotor assembly, wherein the torque may be used to rotate the rotor blades, and a second engine configured to generate a jet exhaust that is adapted to drive the tail sitter aircraft in a forward direction. The tail sitter aircraft further comprises a rotor drive system configured to distribute the torque from the first engine to the proprotor assembly. The first engine is a turboshaft engine, and the second engine is a gas turbine engine.

The tail sitter aircraft further comprises landing members that are positioned to allow the tail sitter aircraft to land and takeoff from a configuration wherein the fuselage longitudinal axis is generally perpendicular to the ground. The tail sitter aircraft further comprises at least one vertical stabilizer. The at least one vertical stabilizer is mounted on one of the wings and is co-located with proprotor assembly. The tail sitter aircraft further comprises canards mounted on the fuselage.

### BRIEF DESCRIPTION OF THE DRAWINGS

Having thus described the invention in general terms, reference will now be made to the accompanying drawings, which are not necessarily drawn to scale, and wherein:

FIGS. 1A-1C illustrates a tail sitter aircraft according to an example embodiment.

FIG. 2 depicts sequential flight operations of a tail sitter aircraft that is capable of rotor-to-wing conversion.

FIGS. 3A and 3B depict the internal components of a tail sitter aircraft according to an example embodiment.

FIG. 4 illustrates an alternative embodiment of a tail sitter aircraft.

FIG. 5 is a block diagram of systems for a tail sitter aircraft that is operable for rotor-to-wing conversion.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

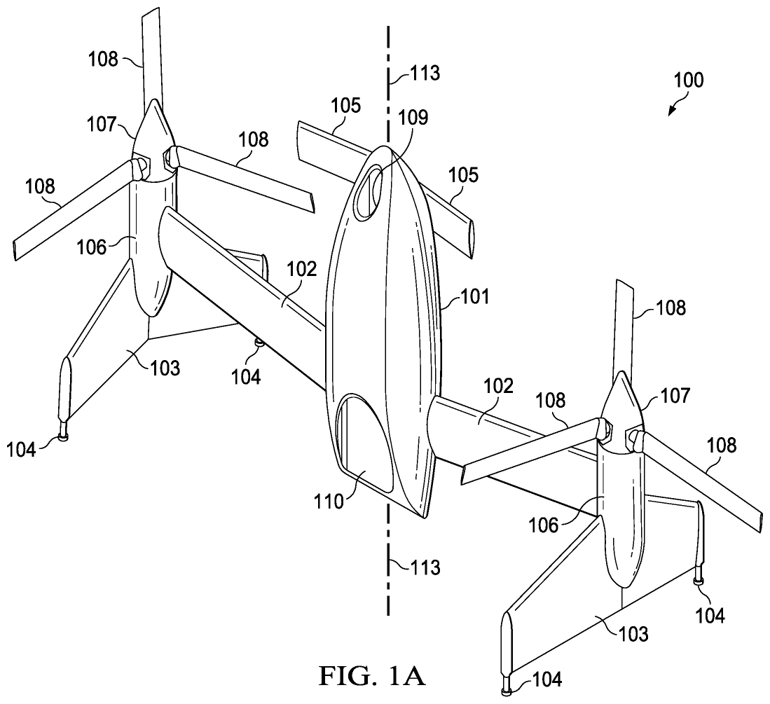

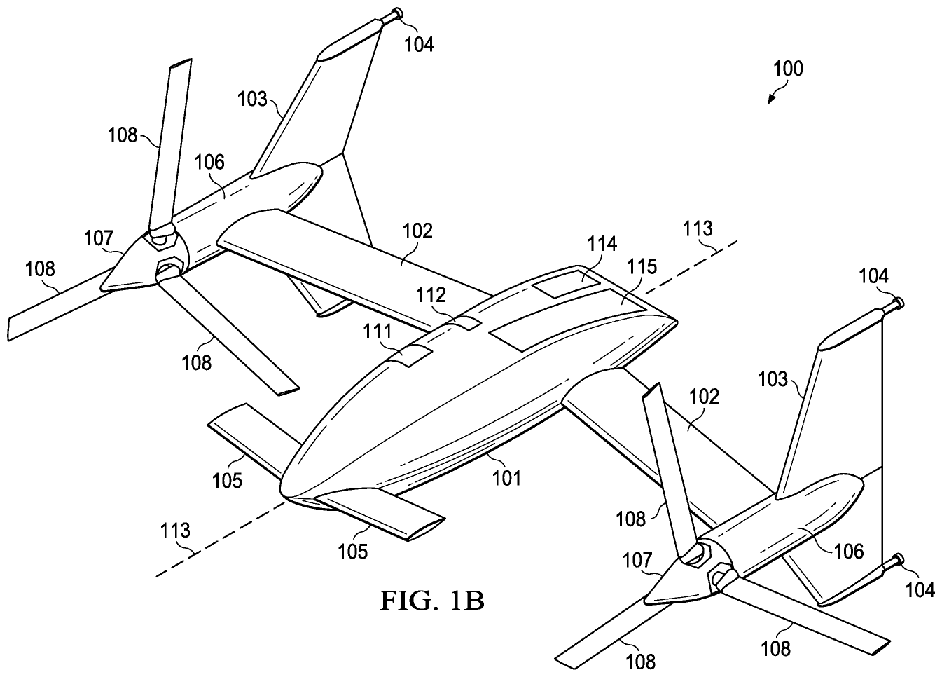

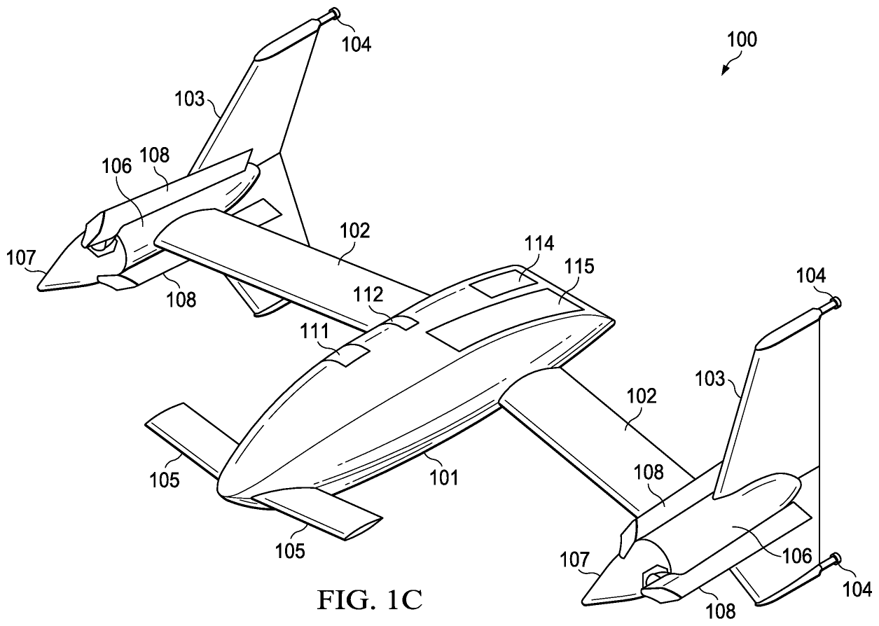

Referring to FIGS. 1A-1C, a tail sitter aircraft 100 is schematically illustrated. Aircraft 100 includes a fuselage 101, wings 102, and vertical stabilizers 103. The wings 102 and vertical stabilizers 103 may include control surfaces, such as ailerons, flaps, slats, spoilers, elevators, rudders, or ruddervators, operable for horizontal and/or vertical stabilization during flight. Wings 102 may be canted forward or aft relative to fuselage for aerodynamic reasons (e.g., rotor blade flapping clearance, aircraft center of gravity, etc.) and/or to reduce radar cross-section and reflectivity. The shape and configuration of other mechanical features of aircraft 100 may be selected for similar reasons. A plurality of landing members 104 extend from vertical stabilizers 103. Landing members 104 may be, for example, fixed or retractable skid members or shock-absorbing members, such as a pneumatic shock struts or mechanical spring assemblies. Landing members 104 may also include wheels (not shown) to assist in ground maneuvers, such as taxiing. Aircraft 100 may have additional aerodynamic control and stabilization surfaces, such as canards 105.

Pylon assemblies 106 are located at the outboard ends of wing 102 and are attached to the wings 102 in a fixed position. Pylon assemblies 106 each house a portion of a rotary drive system that is used to rotate proprotor assemblies 107. The drive system may comprise, for example, one or more engines within fuselage 101 (or in pylon assemblies 106) that are coupled to each of the proprotor assemblies 107 via linkages in wings 102 and pylon assemblies 106. Each proprotor assembly 107 includes a plurality of rotor blades 108 that are operable to be rotated, operable to be feathered, and operable to be folded. When rotating, rotor blades 108 generate forces that are capable of lifting aircraft 100 and/or moving aircraft 100 through an airmass depending upon the orientation of aircraft 100.

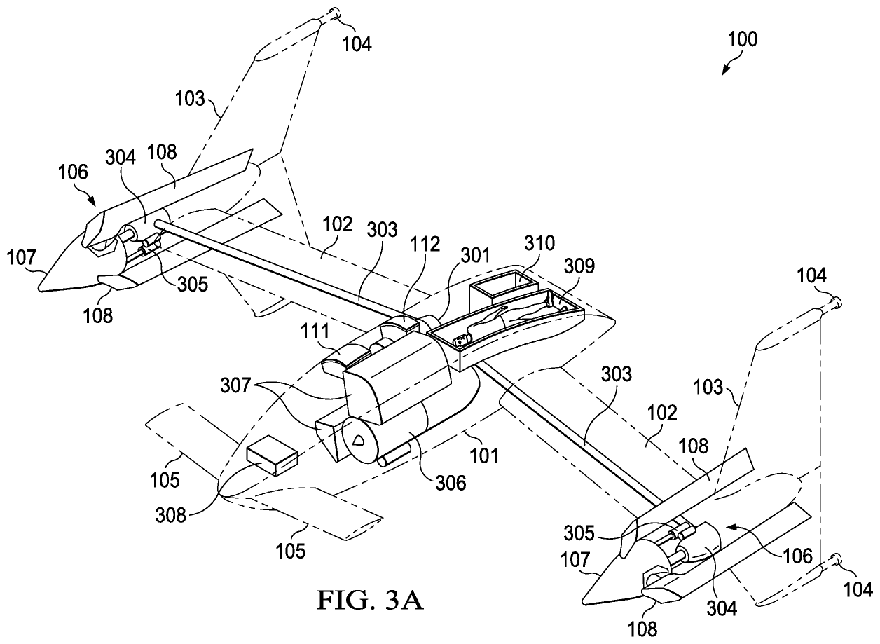

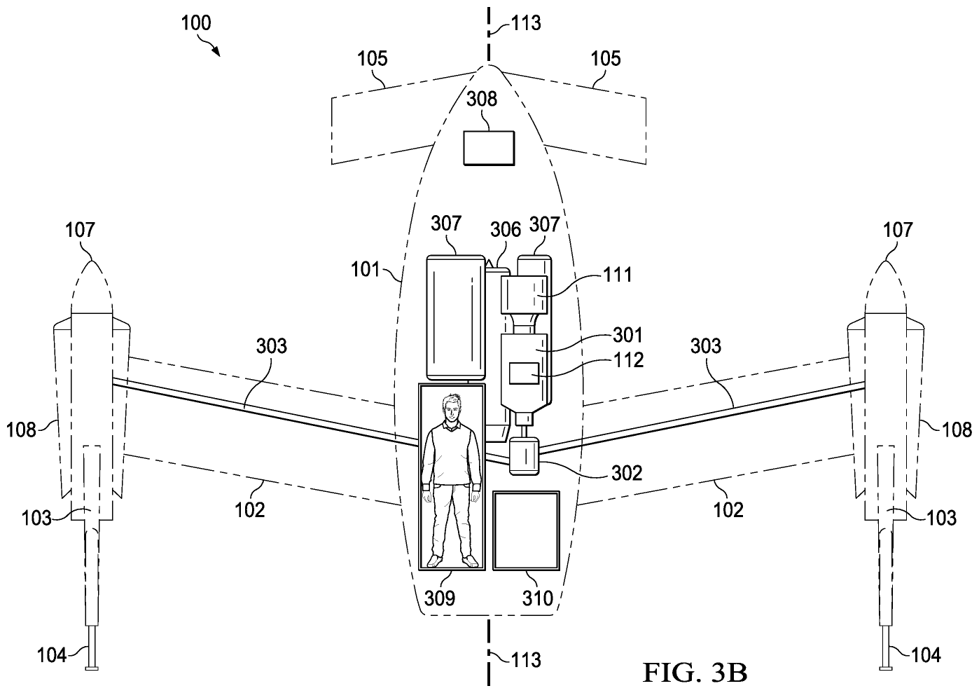

Aircraft 100 may operate in a rotor-driven flight configuration, which is supported by proprotor assemblies 107 and rotor blades 108, and in a jet driven flight configuration, which is supported by an internal gas turbine thrust engine (FIGS. 3A,3B). An air intake 109 supplies an airflow to the internal gas turbine thrust engine, which creates exhaust gases that are passed through exhaust 110. The exhaust gases produce a high-velocity airflow from exhaust 110 that generates thrust for jet-driven flight. A turboshaft engine (FIGS. 3A,3B) in fuselage 101 provides torque to drive proprotors 107 and rotor blades 108. Intake 111 and exhaust 112 provide airflow for the internal turboshaft engine. Although shown aligned with longitudinal fuselage axis 113 of aircraft 100, the intake 111 and exhaust 112 may be located in other positions in alternative embodiments, such as on the sides of fuselage 101.

FIG. 1A illustrates aircraft 100 wherein the longitudinal fuselage axis 113 of the tail sitter aircraft is oriented vertically. Aircraft 100 maintains this general configuration for VTOL or helicopter flight mode so that fuselage 101 and pylons 106 are oriented in a vertical position. In helicopter flight mode, rotor blades 108 rotate in a substantially horizontal plane relative to the ground to provide a lifting thrust, such that aircraft 100 flies much like a conventional helicopter.

FIG. 1B illustrates aircraft 100 in a forward flight mode wherein the longitudinal fuselage axis 113 of the tail sitter aircraft is oriented substantially horizontal. Fuselage 101 and pylons 106 have been rotated forward to a horizontal position so that rotor blades 108 are rotating in a generally vertical plane relative to the ground to provide a forward thrust. In the forward flight mode, wings 102 provide a lifting force responsive to forward airspeed, such that aircraft 100 flies much like a conventional propeller driven aircraft.

In the rotary flight configuration shown in FIGS. 1A and 1B, proprotor assemblies 107 rotate in opposite directions to provide torque balancing to aircraft 100. For example, when viewed from the front of aircraft 100 in proprotor forward flight mode (FIG. 1B) or from the top in helicopter mode (FIG. 1A), one proprotor assembly rotates clockwise, for example, and other proprotor assembly rotates counterclockwise. and operating in counter rotation. The proprotor assemblies 107 are preferably torque matched to prevent aircraft 100 from rotating about is longitudinal fuselage axis 113.

In the illustrated embodiment, proprotor assemblies 107 each include three rotor blades 108 that are equally spaced apart circumferentially at approximately 120-degree intervals. It should be understood by those having ordinary skill in the art, however, that the proprotor assemblies 107 of the present disclosure may have rotor blades with other designs and other configurations including, for example, proprotor assemblies having two, four, five, or more rotor blades.

While in the configuration illustrated in FIG. 1B, aircraft 100 may transition between a rotary-driven forward-flight mode and a thrust-driven forward-flight mode. The internal turboshaft engine in fuselage 101 is disengaged from proprotor assemblies 107. The rotor blades 108 on proprotor assemblies 107 are then feathered (i.e., oriented to be streamlined in the direction of flight). In the feathered position, the rotor blades 108 may act as brakes to aerodynamically stop the rotation of proprotor assemblies 107.

FIG. 1C illustrates aircraft 100 in an airplane forward-flight mode in which rotor blades 108 on proprotor assemblies 107 have been folded so that they are oriented substantially parallel to respective pylon assemblies 106. This configuration minimizes the drag force generated by rotor blades 108. The forward cruising speed of aircraft 100 can be significantly higher in airplane flight mode versus proprotor flight mode as the airspeed-induced proprotor aeroelastic instability is overcome. In this configuration, an internal gas turbine thrust engine provides forward thrust for aircraft 100, thereby enabling wings 102 to provide a lifting force responsive to the forward airspeed. The internal gas turbine thrust engine may be brought online before or while the rotor blades 108 are being stopped, feathered, and folded in order to maintain forward thrust.

Aircraft 100 may also transition from the folded rotor blade configuration of FIG. 1C back to proprotor flight by slowing below a maximum airspeed for rotor blade 108 deployment. Rotor blades 108 may then be swept forward into a feathered configuration. Once all rotor blades are deployed forward and locked into place (as illustrated in FIG. 1B), then the turboshaft engine may again be engaged with proprotor assemblies 107. When torque power is applied to rotate rotor blades 108, aircraft 100 enters proprotor forward flight mode. Aircraft 100 may then transition to a helicopter flight mode by rotating fuselage 101 and pylons 106 from a horizontal orientation (FIG. 1B) to a vertical orientation (FIG. 1A). While transitioning between helicopter flight mode and airplane flight mode, aircraft 100 may operate in a conversion flight mode.

Even though aircraft 100 has been described as having a turboshaft engine and a gas turbine thrust engine in fuselage 101, wherein the turboshaft engine operates both of the proprotor assemblies 107 in rotary flight mode, it should be understood by those having ordinary skill in the art that other engine arrangements are possible and are considered to be within the scope of the present disclosure. For example, in an alternative embodiment, aircraft 100 may have multiple turboshaft engines that provide torque and rotational energy separately to individual proprotor assemblies 107. In further embodiments, a single engine may provide both shaft power to proprotor assemblies 107 in addition to creating jet exhaust so that the single engine may support both rotor-driven and jet-driven flight configurations.

Example apparatuses for folding rotor blades, such as rotor blades 108, are disclosed, for example, in U.S. Pat. Nos. 8,998,125 B2, 10,336,447 B2, and 10,526,068 B2, the disclosures of which are hereby incorporated herein by reference in their entirety. As illustrated in FIG. 1C, rotor blades 108 are foldable relative to proprotor assembly 107 such that rotor blades 108 extend in an aftward direction and are generally parallel to a longitudinal axis of pylons 106. Preferably, rotor blades 108 are coupled to proprotor assembly 107 using lockable hinge members that are operable to lock rotor blades in the radially extending operating configuration of FIGS. 1B and 1C, and in the rearwardly extending storage configuration of FIG. 1C. Operation of rotor blades 108 between the radially extending operating configuration and the rearwardly extending stowed configuration may be automated using, for example, electrically driven actuators. In other embodiments, the movement between extended and stowed positions may be manual, wherein an operator unlocks rotor blades 108 from their current configuration, shifts rotor blades 108 to their desired configuration, and then locks rotor blades 108 in the desired configuration.

Doors or access panels 114 and 115 provide openings to interior compartments that may be used, for example, for crew or passenger stations, avionics equipment racks, mission gear storage, etc. Aircraft 100 may be an unmanned aircraft system (UAS), an unmanned aerial vehicle (UAV), or a drone that is self-powered and does not carry a human operator Aircraft 100 may be autonomously and/or remotely operated and may be expendable or recoverable. Alternatively, aircraft 100 could be a manned aircraft operable for onboard pilot control over some or all aspects of flight operations. In some embodiments, aircraft 100 may carry lethal or nonlethal payloads for use in military, commercial, scientific, recreational and other applications.

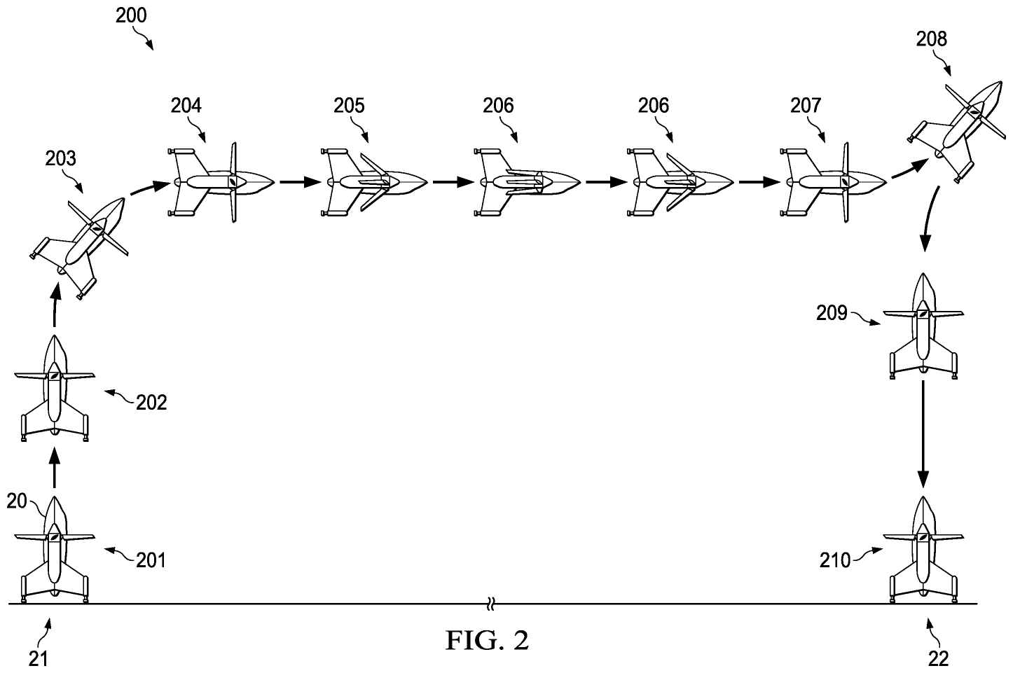

FIG. 2 depicts sequential flight operations 200 of a tail sitter aircraft 20 that is capable of rotor-to-wing conversion, such as, for example, aircraft 100 (FIG. 1). Flight operations 200 illustrate various aircraft modes used to travel between a launch area 21 and a landing area 22. Tail sitter aircraft 20 may be a manned or unmanned aircraft and may be operated responsive to onboard pilot flight control, remote flight control, or autonomous flight control. Tail sitter aircraft 20 is preferably a fly-by-wire aircraft operated by a flight control system having an onboard flight control computing system, such as a digital flight control computer, and a plurality of sensor and controller operably associated with the mechanical systems of aircraft 20 including the engine, transmission and drive systems, rotor assemblies, and pitch/roll/yaw control assemblies to name a few. As shown in takeoff mode 201, tail sitter aircraft 20 is resting on its landing members, such as skids, shock-absorbing struts, or wheels, on the ground at launch area 21. The rotor blades of tail sitter aircraft 20 are extended and locked in takeoff mode. The rotor blades generate lifting force when they are rotating, which allows aircraft 20 to take off and enter a helicopter mode 202. Aircraft 20 may be hovering or ascending in helicopter mode 202 while maintaining its longitudinal fuselage axis in a generally vertical orientation. The rotor blades provide vertical thrust to lift aircraft 20.

Tail sitter aircraft 20 may enter a conversion mode 203 as it transitions from helicopter mode 202 to forward flight. At a desired altitude, aircraft 20 begins to rotate forward so that its longitudinal fuselage axis begins to align parallel with the ground. During conversion mode 203, aircraft 20 performs a rotor-to-wing conversion and the thrust generated by the rotor blades shifts from a lifting thrust in helicopter mode 202 to a forward-flight thrust in prop mode 204. As tail sitter aircraft 20 enters prop mode 204, its wings begin to generate the lifting force required to keep aircraft 20 airborne while the thrust from the rotor blades drive the aircraft forward.

Once established in prop mode 204, aircraft 20 may then transition to a cruise mode in which the aircraft is propelled by a jet engine. An internal gas turbine engine may be engaged to supplement and then replace the forward thrust generated by the rotor blades in prop mode 204. In rotor fold mode 205, the rotor blades are disengaged from their power source, such as a turboshaft engine, and then feathered and stopped. Once the rotor blades stop moving, they may be unlocked and folded to a more aerodynamic position. The rotor blades are secured in the folded position and aircraft 20 enters cruise mode 206 during which the gas turbine thrust engine is providing forward-driving force and the wings are providing lift force. This configuration minimizes the drag force generated by the rotor blades. The forward cruising speed of tail sitter aircraft 20 may be significantly higher in cruise flight mode 206 since this configuration can be optimized for high-speed flight as compared to prop mode 204.

As aircraft 20 approaches its destination 22, it begins to transition back to a rotor-driven configuration. In rotor unfold mode 206, the rotor blades are swept forward to resume a radially extending position. In a second prop mode 207, the rotor blades are then locked in the extended configuration and engaged by a rotor drive system to be coupled again to the turboshaft engine. The gas turbine thrust engine may be shutdown during the second prop mode 207 so that aircraft 20 is only being driven by the rotor blades.

Aircraft 20 the enters a second conversion mode 208 and begins to align its longitudinal fuselage axis from the horizontal orientation of forward flight mode back to the vertical orientation for vertical takeoff and landing. Depending upon factors such as airspeed, altitude, prevailing conditions, and other factors known to those having ordinary skill in the art, aircraft 20 may engage in a variety of maneuvers to achieve this transition. During the wing-to-rotor process of second conversion mode 208, the rotor blades continuously provide thrust that shifts from a forward-direction thrust to a lifting thrust. Likewise, the lifting force provided by the wings decreases as forward speed decreases and angle of attack increases until the rotor blades are providing all of the lifting force when the aircraft enters a second helicopter mode 209.

While in helicopter modes 202 and/or 209, collective and cyclic control can be used to adjust the pitch of the rotor blades to control horizontal and vertical movement of aircraft 20 as it descends to, and hovers over, landing area 22. Finally, tail sitter aircraft 20 touches down on the landing area 22, and the weight of the aircraft transfers to its landing members during landing mode 210. At that time, the rotor blades may be stopped since their lifting force is no longer required. Once stopped, the rotor blades may be unlocked and folded to reduce the space required for parking and storage of aircraft 20.

FIGS. 3A and 3B depict the internal components of aircraft 100 (FIGS. 1A-1C) according to an example embodiment. A turboshaft engine 301 produces shaft power to a main gearbox 302, which in turn drives power shafts 303 within wings 102. Shaft power from engine 301 is transferred by power shafts 303 to rotor gearboxes 304 in each wingtip pylon 106. The rotor gearboxes 304 drive either proprotor assembly 107, which is coupled to a plurality of rotor blades 108. While rotor blades 108 are shown in a folded configuration in FIGS. 3A and 3B, it will be understood that rotor blades 108 may also be unfolded to an extended configuration as shown in FIGS. 1A and 1B. Blade actuators 305 operate to move rotor blades 108 between the extended and folded positions.

Aircraft 100 also comprises a gas turbine thrust engine 306. Thrust engine 306 has one or more air intakes 109 and an exhaust 110 that passes turbine exhaust gases to produce high velocity airflow to generates thrust. When operating in cruise mode as illustrated in FIG. 1C, thrust engine 306 propels aircraft 100 forward and wings 102 generate lift to keep the aircraft airborne. Fuel tanks 307 provide fuel to either or both engines 301 and 306. In some embodiments, thrust engine 306 may provide supplemental lifting force during takeoff, landing, and/or hover modes to augment the lift generated by rotor blades 108.

Turboshaft engine 301 and thrust engine 306 may be located along the longitudinal fuselage axis 113 of aircraft 100 or, as illustrated in FIGS. 3A and 3B, the positions of turboshaft engine 301 and/or thrust engine 306 may be offset from the longitudinal fuselage axis 113 to optimize the location of other aircraft components. Alternatively, two turboshaft engines 301 may be located in pylons 106 and may provide direct drive to proprotor assemblies 107 and rotor blades 108 without requiring main gearbox 302 or power shafts 303.

Although thrust engine 306 is shown as a gas turbine engine in FIGS. 3A and 3B, it will be understood that in other embodiments the thrust engine 306 may be coupled to a propeller (not shown) that is optimized for high-speed flight while rotor blades 108 are optimized to generate lifting force. In such a configuration, the thrust propeller may provide the main forward-driving force in airplane mode.

In a further embodiment, thrust engine 306 may be replaced with a fan section that is driven by turboshaft engine 301 to provide the forward thrust for flight in aircraft mode. In this configuration, an additional drive shaft would couple turboshaft engine 301 to the fan section. The fan section would be selectively engaged once aircraft 100 is beginning or established in forward flight mode. Once the power provide by the fan section and the airspeed are sufficient to maintain forward flight, then engine 301 may be decoupled from proprotor assemblies 107 and rotor blades 108 may be stowed.

Avionics systems 308 are used to monitor and control current aircraft flight conditions. Avionics systems 308 may include, for example, an Air Data Computer (ADC) system that receives inputs from the aircraft's pitot-static system and determines parameters such as true airspeed, pressure altitude, and Outside Air Temperature (OAT); an Attitude-Heading Reference System (AHRS) that senses movement on three axes using gyroscopes and accelerometers to provide attitude information for the aircraft, such as aircraft attitude relative to the pitch, roll, and yaw axes; and/or a Flight Control Computer (FCC) receives inputs from a pilot, such as the motion of a cyclic/collective, control stick/yoke, and/or pedals, and then positions aircraft flight control actuators to achieve a commanded configuration, such as a desired rotor blade position or a desired aileron/rudder/elevator deflection. The FCC may also receive inputs from an autopilot system and/or remote control system in other embodiments. The FCC may also receive inputs from, and provide commands to, an aircraft engine or propulsion system. Avionics systems 308 may further include navigation and communication systems.

Interior compartments 309 and 310 may be used, for example, as crew or passenger stations, for mounting avionics equipment, for mission gear storage, and the like.

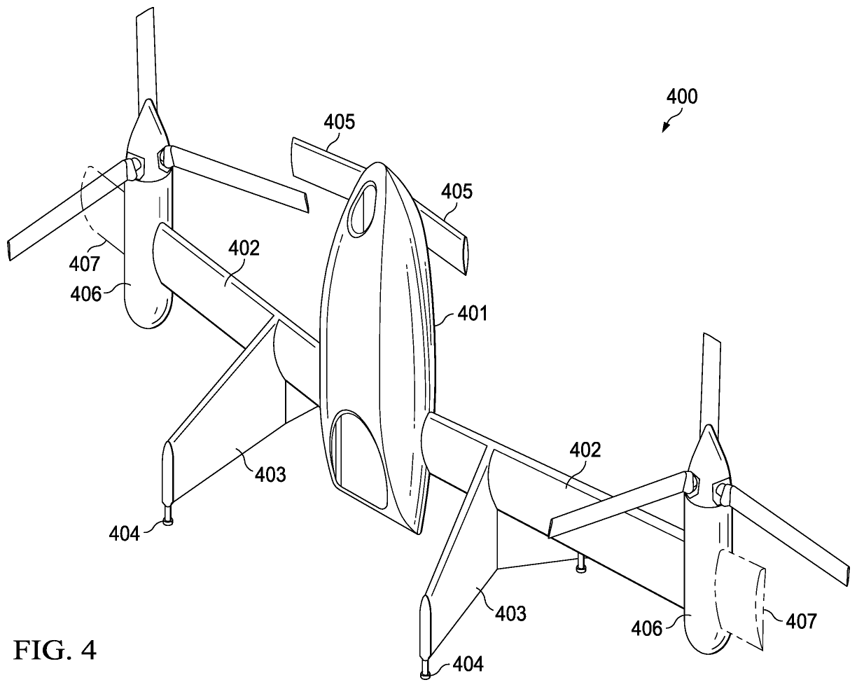

FIG. 4 illustrates an alternative embodiment of a tail sitter aircraft 400. Aircraft 400 includes a fuselage 401, wings 402, and vertical stabilizers 403. Wings 402 and vertical stabilizers 403 may include control surfaces, such as ailerons, flaps, slats, spoilers, elevators, rudders, or ruddervators, operable for horizontal and/or vertical stabilization during flight. A plurality of landing members 404 extend from vertical stabilizers 403. Landing members 404 may be, for example, fixed or retractable skid members or shock-absorbing members, such as a pneumatic shock struts or mechanical spring assemblies, or wheels. Aircraft 400 may have additional aerodynamic control and stabilization surfaces, such as canards 405. Vertical stabilizers 403 are attached to wings 402 and are positioned between wingtip rotor pylons 406 and fuselage 401. Vertical stabilizers 403 may be located at any position along wing 402 that provides a stable platform for aircraft 400 when it rests on landing members 404.

In a further embodiment, rotor pylons 406 may be located at a position inboard of the wingtip so that optional wing sections 407 extend outboard of rotor pylons 406. The wing extensions 407 may provide additional aerodynamic forces on aircraft 400, such as providing additional lift during forward-flight mode. Wing extensions 407 may further comprise additional control surfaces, such as ailerons, flaps, slats, or spoilers. Alternatively, wing extensions 407 may be included on aircraft 100 of FIG. 1A-1C, wherein the pylon assemblies 106 are generally co-located with vertical stabilizers 103 and additional wing extensions may extend outboard from pylon assemblies 106.

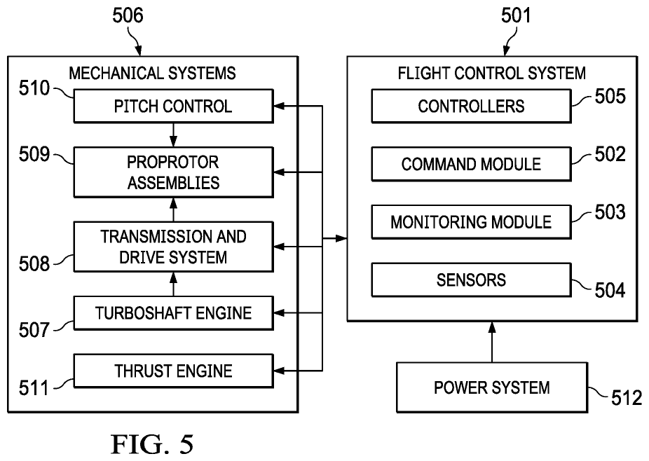

FIG. 5 is a block diagram of systems for a tail sitter aircraft that is operable for rotor-to-wing conversion as set forth in the present disclosure. In the illustrated embodiment, a flight control system 501 includes a command module 502, a monitoring module 503, a plurality of sensors 504, and a plurality of controllers 505. In the illustrated embodiment, mechanical systems 506 include turboshaft engine 507, which drives transmission and drive system 508, proprotor assemblies 509, and pitch control systems 510, and thrust engine 511. Turboshaft engine 507 drives proprotor assemblies 509 via transmission and drive system 508. Alternatively, turboshaft engine 507 may have a direct drive relationship with a proprotor assembly 509.

Turboshaft engine 507 is mechanically coupled to transmission and drive system 508 via a drive shaft or other suitable connection. Transmission and drive system 508 includes one or more clutch assemblies or other suitable engagement assemblies to enable selective coupling and decoupling between turboshaft engine 507 and proprotor assemblies 509 so that engine power to proprotor assembly 509 can be engaged in some modes, such as vertical takeoff and landing mode, and disengaged in other modes, such as forward-flight mode.

Pitch control system 510 includes, for example, a swash plate operable to provide collective pitch control to a proprotor assembly 509 in all operational modes of the tail sitter aircraft. Pitch control assembly 510 provides full helicopter-type pitch control to proprotor assembly 509, including both collective and cyclic pitch control, in vertical takeoff and landing modes, collective pitch control in forward-flight mode, and collective pitch control during rotor-to-wing and wing-to-rotor conversions. Proprotor assemblies 509 and pitch control 510 may cooperatively function to stop and fold the tail sitter aircraft's rotor blades in some flight modes, such as forward-flight or airplane mode.

Thrust engine 511 is, for example, a gas turbine engine that provides a jet thrust force for propelling the tail sitter aircraft during airplane or forward-flight modes. Turboshaft engine 507 and thrust engine 511 may be liquid fuel powered engines, such as gasoline, jet fuel, or diesel powered engine, including gas turbine and rotary engines.

A power system 512, such as battery or electrical generator, provides electrical power to flight control systems 501 either directly or via a power distribution bus. The tail sitter aircraft may be operated autonomously in response to commands generated by flight control system 501, which may be, for example, a digital flight control system that includes a non-transitory computer readable storage medium including a set of computer instructions executable by a processor. Aspects of flight control system 501 may be implemented on a general-purpose computer, a special purpose computer, or other machine with memory and processing capability. For example, flight control system 501 may include one or more memory storage modules including, but not limited to, internal storage memory such as random access memory, non-volatile memory such as read only memory, removable memory such as magnetic storage memory, optical storage, solid-state storage memory or other suitable memory storage entity. Aspects of flight control system 501 may be microprocessor-based systems operable to execute program code in the form of machine-executable instructions. In addition, flight control system 501 may be selectively connectable to other computer systems via a proprietary encrypted network, a public encrypted network, or other suitable communication network that may include both wired and wireless connections.

Flight control system 501 includes a command module 502 and a monitoring module 503. It will be understood by those having ordinary skill in the art that these and other modules executed within flight control system 501 may be implemented in a variety of forms including hardware, software, firmware, special purpose processors, and combinations thereof. Flight control system 501 including a plurality of sensors 504 that obtain input from a variety of sources, such as data relating to parameters of the various mechanical systems 506. In addition, sensors 504 may obtain data relating to other important flight or mission parameters, such as positioning data, attitude data, speed data, environmental data, temperature data, target data, and the like. Flight control system 501 may include a plurality of controllers 505, such as electro-mechanical actuators, that provide inputs to the mechanical systems 506 to enable operations.

In an operational example, flight control system 501 may receive mission instructions from an external source, such as a command and control system. Thereafter, flight control system 501 may autonomously control all aspects of flight of a tail sitter aircraft of the present disclosure. During the various operating modes of the aircraft, including vertical takeoff and landing mode, hovering mode, forward flight mode, and transitions therebetween, command module 502 provides commands to controllers 505 to establish the desired operating positions of the various mechanical systems 506. For example, these commands may relate to the engagement or disengagement of turboshaft engines 507 with proprotor assembly 509, the position of pitch control system 510, and the like. Flight control system 501 receives feedback from sensors 504 that are associated with the various mechanical systems 506. This feedback is processes by monitoring module 503, which supplies correction data and other information to command module 502. Monitoring module 503 preferably receives and processes additional sensor information, such as position data, attitude data, speed data, environmental data, fuel data, temperature data, location data, and the like. Monitoring module 503 provides the processed information to command module 502 to further enhance autonomous flight control capabilities. In some embodiments, some or all of the autonomous control capability of flight control system 501 may be augmented or supplanted by remote flight control from a command and control station via a communication link, such as a wireless communication channel. Alternatively, or additionally, some or all of the autonomous and/or remote flight control of flight control system 501 may be augmented or supplanted by onboard pilot flight control in manned embodiments.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A tail sitter aircraft, comprising:
a fuselage having a longitudinal axis;
a wing attached to the fuselage at a first end of the wing;
a proprotor assembly having a plurality of rotor blades, the proprotor assembly mounted at a second end of the wing so that an axis of the proprotor assembly maintains an alignment that is generally parallel to the fuselage longitudinal axis, wherein the plurality of rotor blades are configured to move between an extend position and a folded position;
a first engine configured to generate torque, wherein the proprotor assembly is configured to rotate the rotor blades using torque generated by the first engine; and
a second engine configured to generate a thrust force that is adapted to drive the tail sitter aircraft in a forward direction.

2. The tail sitter aircraft of claim 1, further comprising:
a rotor drive system configured to distribute the torque from the first engine to the proprotor assembly.

3. The tail sitter aircraft of claim 1, wherein the first engine is a turboshaft engine, and the second engine is a gas turbine engine.

4. The tail sitter aircraft of claim 1, wherein the thrust force generated by the second engine comprises exhaust airflow from a turbine engine.

5. The tail sitter aircraft of claim 1, wherein the first engine and the second engine are a single gas turbine engine coupled to a power shaft to provide torque and a fan section to provide thrust.

6. The tail sitter aircraft of claim 1, further comprising:
landing members positioned to allow the tail sitter aircraft to land and takeoff from a configuration wherein the fuselage longitudinal axis is generally perpendicular to the ground.

7. The tail sitter aircraft of claim 6, wherein the landing members are selected from the group consisting of: skid members, shock-absorbing members, pneumatic shock struts, mechanical spring assemblies, and wheels.

8. The tail sitter aircraft of claim 1, further comprising:
a vertical stabilizer.

9. The tail sitter aircraft of claim 8, wherein the vertical stabilizer is mounted on the wing and co-located with the proprotor assembly.

10. The tail sitter aircraft of claim 1, further comprising:
canards mounted on the fuselage.

11. The tail sitter aircraft of claim 1, further comprising:
a pylon for mounting the proprotor assembly at the second end of the wing.

12. The tail sitter aircraft of claim 11, further comprising:
a wing extension attached to the pylon in a position outboard of the wing.

13. The tail sitter aircraft of claim 11, wherein the first engine is mounted within the pylon.

14. A tail sitter aircraft, comprising:
a fuselage having a longitudinal axis;
two wings attached to the fuselage and extending outward from the fuselage on opposite sides of the tail sitter aircraft;
a pylon mounted on each wing, the pylon configured to hold a proprotor assembly having a plurality of rotor blades, an axis of rotation for the rotor blades having an alignment that is generally parallel to the fuselage longitudinal axis, wherein the plurality of rotor blades are configured to move between an extend position and a folded position;
a first engine configured to provide torque to at least one proprotor assembly, wherein the torque may be used to rotate the rotor blades; and
a second engine configured to generate a jet exhaust that is adapted to drive the tail sitter aircraft in a forward direction.

15. The tail sitter aircraft of claim 14, further comprising:
landing members positioned to allow the tail sitter aircraft to land and takeoff from a configuration wherein the fuselage longitudinal axis is generally perpendicular to the ground.

16. The tail sitter aircraft of claim 14, further comprising:
a rotor drive system configured to distribute the torque from the first engine to the proprotor assembly.

17. The tail sitter aircraft of claim 14, wherein the first engine is a turboshaft engine, and the second engine is a gas turbine engine.

18. The tail sitter aircraft of claim 14, further comprising:
at least one vertical stabilizer.

19. The tail sitter aircraft of claim 18, wherein the at least one vertical stabilizer is mounted on one of the wings and is co-located with proprotor assembly.

20. The tail sitter aircraft of claim 14, further comprising:
canards mounted on the fuselage.
